(19) United States
(12) Patent Application Publication
(10) Pub. No.: US 2020/0273291 A1
(43) Pub. Date: Aug. 27, 2020

(54) Jackpot or progressive wager for card games

(71) Applicant: Raphael Mourad, Toronto (CA)

(72) Inventor: Raphael Mourad, Toronto (CA)

(21) Appl. No.: 16/501,406

(22) Filed: Apr. 10, 2019

Related U.S. Application Data
(60) Provisional application No. 62/761,771, filed on Apr. 5, 2018.

(51) Int. Cl. G07F 17/32

(52) U.S. Cl. CPC G07F 17/3258; G07F 17/3293

(57) ABSTRACT

In table games setup, winning hands in card games are mostly paid one to one (even money) on the main wager, and tens to one on side wagers. This invention discloses wagers in disclosed new and existing games which allow jackpot or progressive high payouts up to a hundred thousand to one, without affecting the simplicity and integrity of the game. The disclosed games and wagers are presented to be played in social encounters, and in particular to be played in gambling establishments, mainly in a table game setup and not only in a single or multi-player electronic system.

This application claims priority of provisional application No. 62/761,771 filed on Apr. 5, 2018

### FIELD OF THE INVENTION

This invention relates to jackpot or progressive wagers and payouts in card games in social encounters or in gambling establishment.

### BACKGROUND ART

A wide variety of games are known in the gaming industry, including social games and games played at casinos. In general, games at casinos are divided into two main categories; slot/video machines and table games. Most of the slot/video machines offer games of pure chance, while table games offer games of pure chance and games with a skill component.

Since slot/video machines are designed and built using computers and data processors that can handle a very large number of symbols and data and can process a very large number of possible outcomes, say between 10,000 and 1,000,000, and as such, payouts on unique winning combinations could be very high. Games played in slot machines, that mostly use and display symbols or characters, could therefore have large jackpot payouts that could reach hundreds of thousands to one, Mega Jackpot. The use of a large number of symbols or characters on each reel, associated with variable frequencies of their display, allows the designer of slot/video machines to achieve jackpot payouts combinations associated with a very low hit frequency. However, the majority of the current slot/video machines are designed with a higher hit frequency and smaller payouts of 10 to 1 (mini Jackpot), 25 to 1 (Minor Jackpot), 100 to 1 (Major Jackpot) and up to a thousand to 1, (Grand Jackpot).

Games played in table game setup, however, could be games of pure chance (such as craps, Roulette, Casino war, Big Wheel and Baccarat) or games with a skill component (such as BlackJack and Poker-type games). Since these games are not using any computers or data processors, the number of possible and manageable outcomes in these games must be very limited, say between 10 and 100, and as such payouts are limited to low values. Winners in these games are paid one to one (even money) on the main wager placed by game participants, such as in Casino War, and in the most popular games Blackjack and Baccarat. Higher payouts, up to tens to one on the main wager are also available on other table games, (such as Roulette, Craps, Big Wheel, and poker-type games) and on side bets on these table games, (such as Match the Dealer, Perfect Pairs, Lucky Ladies, Dragon Bonus and Pairs). Since the number of possible outcomes or combinations in these games is relatively small, payouts on winning combinations are relatively small, say up to one hundred to one. Jackpot-like payouts, ten thousand to one million to 1, are very hard to implement in table game setup without the use of computers and data processors and without affecting the simplicity and integrity of the game.

This invention discloses wagers on new games and side or bonus wagers on existing games that entitles winners to get paid higher payouts up to one hundred thousand to one. The advantageous of the present disclosure provides games of pure chance that can be played in social encountering and in gambling establishments, of high jackpot like payouts, without the use of computers and data processors and without impacting the simplicity, fairness, honesty and integrity of the wagering game.

### SUMMARY OF THE PRESENT DISCLOSURE

The present disclosure provides side bets or bonus wagers, that potentially can win very high jackpot like payouts, on the following games; “NINES” in the game BACCARAT, “HOUSE 2021” in a new game JACKARAT, “JACKPOT STEP 5” in the game STEP POKER, and “PLAYER 2021” in the game BLACJACK. Maximum payouts on these wagers is 100,000 to 1, implemented in games that can be played at social encountering but in particular, in gaming establishments or casinos, in table game setups and not only in single player slot/video machines or in multi-players electronic setups.

### BRIEF DESCRIPTION OF THE DRAWINGS

So the those having ordinary skill in the art to which the present disclosure pertains will more readily understand how to make and use the subject invention, exemplary embodiments will be described in detail herein below with reference to the drawings, wherein:

FIG. 1 is a Table showing winning hands combinations and payouts on Jackpot wager “NINES”.

FIG. 2 is a Table showing winning hands combinations and payouts on Jackpot wager “HOUSE 2021”.

FIG. 3 is a Table showing winning hands combinations and payouts on Jackpot wager “JACKPOT STEP 5”

FIG. 4 is a Table showing winning hands combinations and payouts on Jackpot wager “PLAYER 2021” The disclosure clearly passes the section 101 rejection imposed by the court in In Re Smith, 815F3d816, when dealing with a “conventional card game” on the basis that the claims defined an abstract idea analogous to the economic ideas considered in Alice and Bilski. There is nothing economic involved in the invention or in claims 1 through 12 as they do not simply define wagering games but defines wagers in games that provide Jackpot-like payouts up to 100,000 to 1, similar to those in slot/video machines, without the use of computers and data processors and without affecting the simplicity and integrity of the games. However, like all contests, such as board games like chess or checkers, or sporting events between teams or multiple parties such as races and poker games, wagers may be based on the result of the contest or of the game. The present invention is applied into four exemplary games; games being played in social encounters, in gambling establishment, in a table game setup and not only in a single or multi-player electronic system.

### DETAILED DESCRIPTION OF EXEMPLARY EMBODIMENTS

In an exemplary embodiment, the Jackpot Wager “NINES” is associated with the famous game BACCARAT.

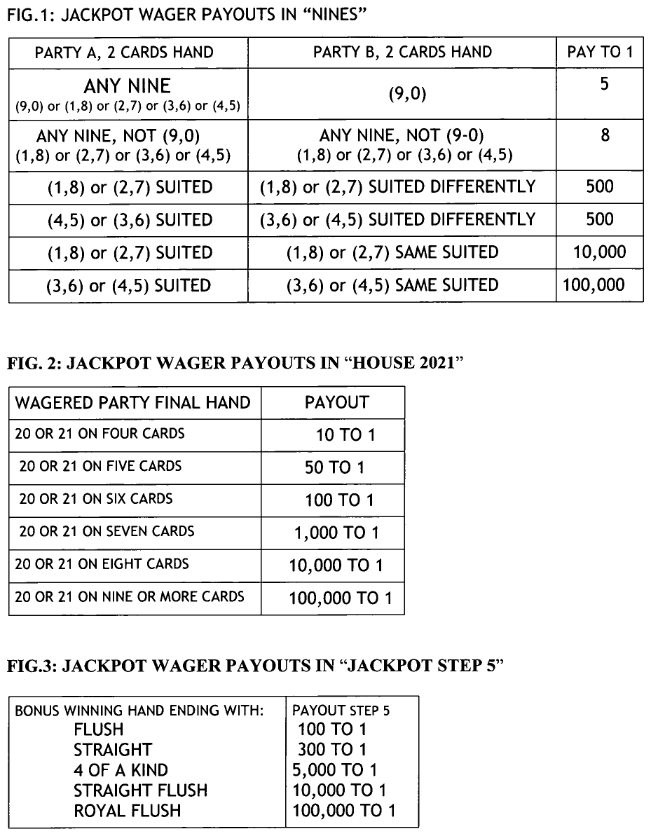

The or each participant in the conventional BACCARAT game who places an initial main wager on one of two parties, PLAYER or BANKER, has the option to place a Jackpot Wager on “NINES” at the start of round of play. Two cards are exposed to “PLAYER” and two cards are exposed to “BANKER” randomly from a card shoe. Using the BACCARAT scoring system, the score of each party two card hand is between 0 and 9. The Jackpot Wager on “NINES” wins if the score of each of the two parties' 2-card hand is 9. A score of 9 in 2-card is achieved with the following combinations; 5/4, 6/3, 7/2, 8/1 and 9/0. When 8 decks of cards are used and payouts as given in FIG. 1, the HIT Frequency is 0.89% and the Casino Advantage is 2.48%. The Hit Frequency of the Jackpot payout of 100,000 to 1 is less than 1 in 100,000 (0.00000785).

As noted from FIG. 1, the Jackpot Wager “NINES” is a win if both parties hands scores are nines, otherwise it is a loss. If the Jackpot Wager is a win, then the play ends (wagers on “NINES” are paid and the two parties push on the main wager) and a new round starts. If the Jackpot Wager “NINES” is a loss then wagers on “NINES” are collected and the play continues according to the BACCARAT rules to decide on the fate of the main wager.

Indeed, the incorporation of the Jackpot Wager “NINES” in the BACCARAT game is providing Jackpot-like payouts up to 100,000 to 1, without affecting the simplicity (to play, to deal and to manage) and the integrity (honesty, card counting) of the game.

In another exemplary embodiment, a Jackpot Wager “HOUSE 2021” is introduced in a new game “JACKARAT”.

The or each participant who places an initial ante bet on HOUSE 1 or on HOUSE 2, has the option to place a Jackpot Wager on “HOUSE 2021”. Like in Baccarat, 2 cards are dealt to HOUSE 1 and 2 cards are dealt to HOUSE 2. The scoring of hands is in accordance to the scoring system used in the BlackJack game. Additional cards are dealt to HOUSE 1 and to HOUSE 2, in accordance to the HOUSE rules in BlackJack i.e. to form a hand with a score between 17 and 21 or breaks (more than 21). After the dealing is complete, the fate of the main wager is settled by comparing the two scores. The Jackpot Wager is a loss if the score of the wagered party is less than 20 or more than 21 and is a win if the score of the wagered party is 20 or 21. The play then ends and a new round starts.

When 8 decks of cards are used and payouts as given in FIG. 2, the HIT Frequency is 4.42% and the Casino advantage is 7.47%. The Hit Frequency of the Jackpot payout of 100,000 to 1 is less than one in a million (0.000000115).

Indeed, the incorporation of the Jackpot Wager “HOUSE 2021” in the suggested simple game “JACKARAT” is providing Jackpot-like payouts up to 100,000 to 1, without affecting the simplicity (to play, to deal and to manage) and the integrity (honesty, card counting) of the game.

In another exemplary embodiment, a Jackpot Wager “JACKPOT STEP 5” is associated with the game STEP POKER which is played with a single deck of cards.

The or each participant in the game who placed 5 independent wagers on STEP 1, STEP 2, STEP 3, STEP 4 and STEP 5, has the option to place a Jackpot Wager on “JACKPOT STEP 5”. Players are dealt one card in step 1, and a second card in step 2, to form a 2-card poker hand. When the wager in step 2 is a win, player is dealt a third card to form a 3-card poker hand. When the wager in step 3 is a win, player is dealt a forth card to form a 4-card poker hand. When the wager in step 4 is a win, player is dealt a fifth card to form a 5-card poker hand. Player wins the “JACKPOT STEP 5” if player gets to and wins the wager in step 5. When the payouts as given in FIG. 3 are used, the Hit Frequency is 0.27% and the Casino Advantage is 3.04%. The Hit Frequency of the Jackpot payout of 100,000 to 1 is less than one in 100,000 (0.00000154).

Indeed, the incorporation of the Jackpot Wager “JACKPOT STEP 5” in the STEP POKER game is providing Jackpot-like payouts up to 100,000 to 1, without affecting the simplicity (to play, to deal and to manage) and the integrity (honesty, card counting) of the game.

In another exemplary embodiment, a Jackpot Wager “PLAYER 2021” is associated with the most famous game in the world BLACKJACK.

The or each participant who placed an initial main bet to play BlackJack against the House, may also place an optional Jackpot Wager on “PLAYER 2021”. The or each participant is dealt two cards face up and the House is dealt one card face up and one card face down. The or each participant may choose to stand pat, to split two equal value cards or to withdraw additional cards, all at the participant personal strategy and decision but within the rules and restrictions of the BlackJack game.

The Jackpot Wager on “PLAYER 2021” pays if the player's hand achieves a score of 20 or 21, with higher payouts when the score is achieved with a larger number of cards.

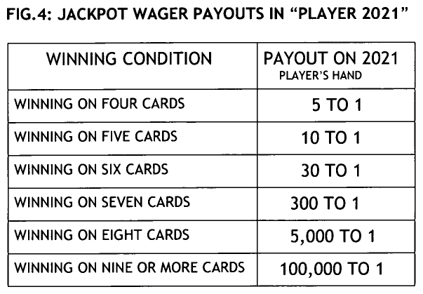

When the size of the Jackpot wager is limited to the size of the main wager, 8 decks of cards are used, and participants can't withdraw additional cards on a hand that achieved the score of 20 or 21, the Hit Frequency is less than 7.27% and the combined Casino Advantage on the main and Jackpot wagers is more than 2.1% with the payouts as given in FIG. 4. The Hit Frequency of the Jackpot payout of 100,000 to 1 is less than one in 100,000 (0.0000063).

Indeed, the incorporation of the Jackpot Wager “PLAYER 2021” in the BlackJack game is providing Jackpot-like payouts up to 100,000 to 1, without affecting the simplicity and the integrity of the game. It is demonstrated that the disclosed invention of rewarding Jackpot like payouts is simply and fairly implemented in table game setups without the use of computers and data processors. Since the process of implementing the disclosed invention in single or multi players slot/video machine electronic setups, that uses computers and data processors, is obvious to those having ordinary skill in the art to which the present disclosure pertains, this process is indirectly claimed but not implicitly addressed or directly claimed herein.

1. A method of playing a game consisting of at least one participant, the use of a single or multiple sets of decks of cards, each deck comprising of the 52 standard playing cards and may include one or more wild cards;
Whereas the or each participant has the option to place a Jackpot Wager on party A and/or on Party B;
Whereas each party receives randomly two cards to form a “Hand” and each “Hand” is ranked and evaluated within a predetermined scoring system;
Whereas Jackpot Wagers placed win if the score of each “Hand” is S1 to S2;
Whereas winners Jackpot wagers potentially can win payouts up to a 100,000 to 1.

2. The method of claim 1 whereas the Baccarat scoring system is used and S1=S2=9.

3. The method of claim 2 whereas no wild cards and 8 decks are used and winning hands are paid in accordance to FIG. 1.

4. A method of playing a game consisting of at least one participant, the use of a single or multiple sets of decks of cards, each deck comprising of the 52 standard playing cards and may include one or more wild cards;
Whereas the or each participant has the option to place a Jackpot Wager on party A or Party B;
Whereas each party receives randomly two cards;
Whereas each party may receive additional cards in accordance to established rules to form a “Hand” and each “Hand” is ranked and evaluated within a predetermined scoring system;
Whereas Jackpot Wagers placed win if the respective party “Hand's” score is S1 to S2;
Whereas winners Jackpot wagers potentially can win payouts up to 100,000 to 1.

5. The method of claim 4 whereas the BlackJack scoring system is used, withdrawal of additional cards to both parties in accordance to the House rules in the BlackJack game, and S1=20 and S2=21.

6. The method of claim 5 whereas no wild card and 8 decks are used and winning hands are paid in accordance to FIG. 2.

7. A method of playing a game consisting of at least one participant, the use of a single deck of cards, the deck comprising of the 52 standard playing cards and may include one or more wild cards;
Whereas the or each participant places W (W>=3) independent wagers on STEP 1, STEP2, up to STEP W, and a predetermined fixed Jackpot Wager on Bonus STEP W;
Whereas the or each participant receives randomly one card at each step to form a “Hand” and each “Hand” is ranked and evaluated within a predetermined scoring system;
whereas Jackpot wagers win if all the wagers in STEP 1 to STEP W have won;
Whereas Jackpot winners potentially can win payouts up to 100,000 to 1.

8. The method of claim 7 whereas W=5 and the poker scoring system is used.

9. The method of claim 8 whereas no wild cards are used and winning hands are paid in accordance to FIG. 3.

10. A method of playing a game consisting of at least one participant, the use of a single or multiple sets of decks of cards, each deck comprising of the 52 standard playing cards and may include one or more wild cards;
Whereas the or each participant has the option to place a Jackpot Wager while playing the BlackJack game against the house;
Whereas the or each participant receives randomly two cards;
Whereas the or each participant may receive additional cards in accordance to the BlackJack established rules to form a “Hand” and each “Hand” is ranked and evaluated according to the BlackJack scoring system;
Whereas Jackpot Wagers placed win if the or each participant “Hand's” score is S1 to S2;
Whereas winners Jackpot wagers potentially can win payouts up to 100,000 to 1.

11. The method of claim 10 whereas S1=20 and S2=21.

12. The method of claim 11 whereas no wild card and 8 decks are used and winning hands are paid in accordance to FIG. 4.
